(19) United States
(12) Patent Application Publication
(10) Pub. No.: US 2015/0121244 A1
(43) Pub. Date: Apr. 30, 2015

(54) Building a Realized Topology with a Binding Document

(71) Applicant: HEWLETT-PACKARD DEVELOPMENT COMPANY, L.P., Houston, TX (US)

(72) Inventors: Jeffrey Joel Walls, Fort Collins, CO (US); Tapan Sharma, Corvallis, OR (US); Mark Perreira, Cupertino, CA (US); Bryan P. Murray, Duvall, WA (US)

(73) Assignee: HEWLETT-PACKARD DEVELOPMENT COMPANY, L.P., Houston, TX (US)

(21) Appl. No.: 14/069,113

(22) Filed: Oct. 31, 2013

(51) Int. Cl. H04L 12/24; G06F 3/0481

(52) U.S. Cl. CPC H04L 41/22; G06F 3/0481
USPC 715/744

(57) ABSTRACT

Building a realized topology with a binding document includes generating a binding document based on user input, assigning values to the binding document, and building a realized topology based on the binding document such that a user interface to the realized topology is tied to the binding document and is independent of a cloud.

### BACKGROUND

A cloud is a group of computing devices connected through a real-time communication network, such as the internet, that are organized to perform network based services. The cloud may employ the use of physical computing devices or virtual devices. The resources of the computing devices are shared to maximize efficiencies. The cloud can operate to run programs remotely on client devices, store an enormous amount of data, perform complex tasks, and other functions. A cloud can be set up for the use of a customer. A customer can order a cloud from a service provider that meets the customer's desired characteristics.

A realized topology can be defined in a multiple task process. Initially, the topology description of the realized topology is designed. This topology description is taken and concrete values for the attributes of each component are provided to create a binding document. Later, the binding document having the concrete values is deployed to the cloud to create the realized topology.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram of an example of a building system according to the principles described herein.

FIG. 2 is a diagram of an example of a binding document according to the principles described herein.

FIG. 3 is a diagram of an example of a user interface according to the principles described herein.

FIG. 4 is a diagram of an example of a method for building a realized topology with a binding document according to the principles described herein.

FIG. 5 is a diagram of an example of a method for building a realized topology with a binding document according to the principles described herein.

FIG. 6 is a diagram of an example of a method for building a realized topology with a binding document according to the principles described herein.

FIG. 7 is a diagram of an example of a building system according to the principles described herein.

FIG. 8 is a diagram of an example of a building system according to the principles described herein.

### DETAILED DESCRIPTION

Often, realized topologies built for customers are based on the infrastructure of the cloud, such as the servers, versions of the cloud components, and so forth, and the realized topology users can interact with the realized topology through a user interface. However, when something in the cloud changes, such as a component's version, the user interface is also updated.

Usually, a customized user interface is used to create and interact with topology documents. Such user interfaces are often inflexible and become out of date very quickly. When there are changes to the binding logic, the user interface code has to be modified, recompiled, and redelivered. This can be very expensive. The principles described herein include a table driven binding approach where a binding document is all that has to be changed to provide a correct user interface. With this approach, clouds can evolve naturally over time, and the binding document can always be up to date.

This approach resolves the above mentioned issues by creating and future-proofing a binding document which defines a realization of the infrastructure topology. It creates a mechanism whereby a simple binding document is used to define and specify the complex relationships of the topology description objects and their attributes for a given cloud. With the table driven binding approach, a binding document is all that has to change to provide a correct user interface.

The principles described herein simplify the process of building a customer realized topology with a binding document that reduces and/or eliminates the user interface changes resulting driven by cloud changes. Such a method may include generating a binding document based on user input, assigning values to the binding document, and building a realized topology based on the binding document such that a user interface to the topology description is tied to the binding document and is independent of a cloud. As a result, the user interface displays the topology description elements in a consistent and familiar format, but according to a set of rules that will ensure that the data is correct at submission time. Further, complex relationships and rules pertaining to the topology description can be expressed in a simple user interface.

A topology description is a design that expresses the user's intent about what they would like to create in the cloud. Such a topology description is described in a template. When values are assigned to the template, the template becomes the binding document mentioned above.

A realized topology is a set of compute, storage, and network resources that realize a topology description to run this in the cloud. The realized topology is built using the binding document.

A cloud is a set of generic compute, storage, and network resources that enable a user to create virtual infrastructure for their applications according to their requirements as expressed by a topology description. As stated above, the cloud is independent of the realized topology.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

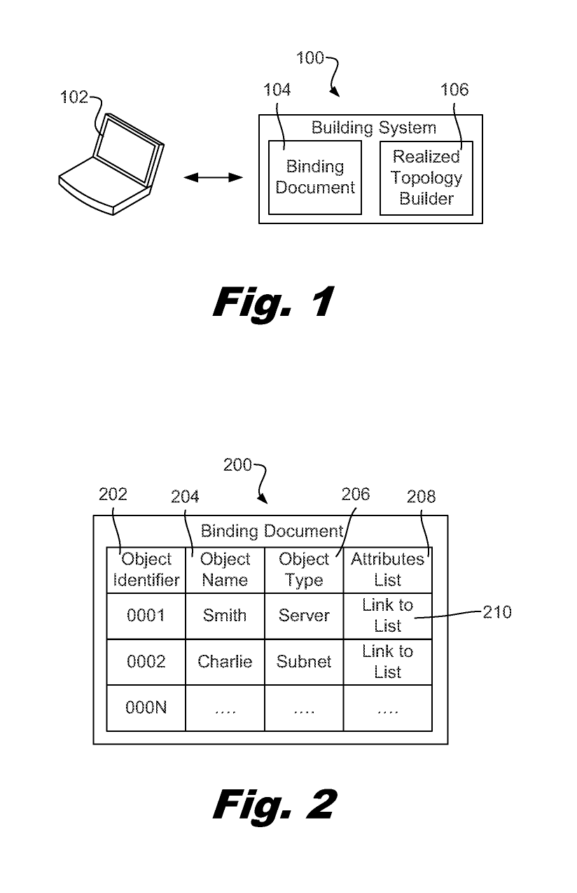

FIG. 1 is a diagram of an example of a building system (100) according to the principles described herein. In this example, a user interface (102) is in communication with the building system (100). The building system (100) includes a binding document (104) and a realized topology builder (106).

The user interface (102) may be any appropriate type of user interface. For example, the user interface (102) may include a personal computer, a laptop, a desktop, an electronic tablet, a mobile device, another type of device, or combinations thereof. The user may send instructions to the building system (100) through the user interface (102). In some examples, the user interface (102) is incorporated directly into the building system (100). However, in other examples, the user interface (102) communicates with the building system (100) remotely.

The binding document (104) includes at least one table that tracks the relationships between the topology description objects and their attributes. The building system (100) may request information from the user about what parameters and characteristics the user desires for the cloud. The building system (100) uses the user input to determine which resources to use in the system and creates a template that describes the user input. For example, the user may instruct the building system (100) through the user interface (102) that the realized topology should include a certain amount of storage, and the building system (100) writes to the template the amount of storage and any other characteristics provided by the user about the desired storage.

The building system (100) will assign values to the template to create a binding document (104). In some examples, the values are obtained through the user. For example, the user may request that the topology description include a server, and the building system (100) may provide a list of attributes that are compatible with the cloud's infrastructure for such a requested server. In response to the user selecting a set of parameters for the server, the building system (100) assigns the selected values to the server object in the binding document (104). In some examples, the building system (100) assigns default values to the topology description objects selected by the user where applicable and just provides options to the user that make sense. In some examples, the building system (100) attempts to use the default values as much as possible.

In other examples, the user may request a different capability that can be handled with an existing realized topology object. In such an example, the attributes of the topology description object are already assigned to the referenced realized topology object, and the user may not be given an option to change the existing attributes.

The realized topology builder (106) builds the realized topology based on the binding document. Thus, the cloud characteristics are reflected in the binding document. If changes are made to the binding document, the instructions sent to the cloud are changed accordingly. However, the user interface (102) remains consistent when the changes are made to the cloud. In other words, the cloud is decoupled or independent of the user interface (102) and changes to the cloud are transparent to the user. Thus, as the versions to operating systems, physical cloud components, virtual cloud components, or other components of the cloud change, the user may be unaware of these changes. This provides consistency for the user who does not have to re-familiarize himself with the cloud through the user interface (102) whenever a change has been made to the cloud.

FIG. 2 is a diagram of an example of a binding document (200) according to the principles described herein. In this example, the binding document (200) includes an object identifier column (202), an object name column (204), an object type column (206), and an attribute list column (208).

The object identifier column (202) includes a numerical identifier that can be used by the building system to track the objects of the topology description. The object name column (204) includes the names that the user gives to the topology description object. Such a name may be displayed in the user interface, and is a name that is easily identifiable to the user.

The object type describes the type of topology description object. The binding document (200) may be used to describe any appropriate type of topology description object including objects that are classified as belonging to servers groups, volume groups, subnets, networks, other appropriate types of type categories, or combinations thereof.

The attribute list column (208) includes a mechanism to determine the attributes associated with the topology description object. In some examples, the attributes are directly inputted in the attributes list column (208). In other examples, the attributes are embedded and are displayed in the user interface when the appropriate table cell is selected. Such a selection may occur when a cursor is hovered over the cell of interest. In other examples, the attributes list column (208) includes a link (210) to a list of the attributes.

When creating a binding document tool, the user often is concerned with multiple things: the objects, the attributes of each object, and the association among the attributes and objects. Here, a series of tables are created that describe these things. At least one table defines the possible object types and the attributes for that object. Such a table can include an identifier, display name, reference to a list of attributes, data type for the attributes, a representation of the output that should be generated, a mechanism for validating the user supplied value for the attributes, and a reference to a grouping to other attributes for that object.

There are cases when some attributes simply are not valid for the given topology description. Also, there are other cases when attributes should to be visible or hidden depending upon user selections. For example, if the user selects “create a subnet” option under a network object, the building system can request a set of inputs (e.g., name, address mask size, description, etc.) from the user. However, if an existing subnet is selected instead, those values should be hidden. The principles described herein include the creation of a set of show/hide tables and associate objects with their attributes. The same approach can be used for value dependencies. For example, if a specific value is chosen from a drop down list in the binding document, then another user interface control should to be shown or hidden. Another similar feature is to show or hide values depending upon what version of cloud they are binding to. For example, if the OpenStack version is “Essex,” then a set of fields are applicable, but if the OpenStack version is “Grizzly,” a different set of fields are applicable.

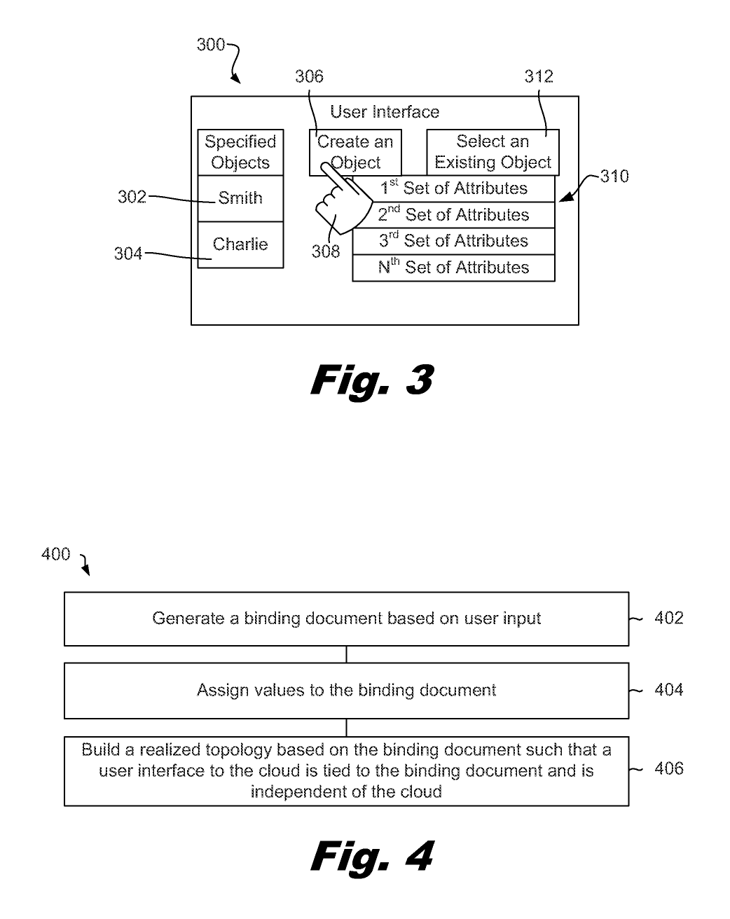

FIG. 3 is a diagram of an example of a user interface (300) according to the principles described herein. In this example, the user interface (300) displays topology description objects (302, 304) that have already been specified by the user, which are identified with the user assigned name.

A first button (306) is displayed in the user interface that gives the user an option to create a new topology description object. A cursor (308) is depicted as having selected the first button (306), and as a result, a drop down menu (310) is depicted which provides the user with a compatible sets of attributes for the selected object.

A second button (312) is also depicted in the user interface (300). This button (312) allows the user to select an existing object to be used in the topology description.

While this example has been described with reference to buttons specifically for selecting topology description objects, any appropriate type of mechanism may be used to select objects. Further, other options may be depicted in the user interface (300) or the depicted options may be expressed in different ways. While this example displays a specific look and feel for guiding the user to provide input on what should be included in the cloud, any appropriate type of arrangement may be used.

The options provided to the user may be intended to obtain feedback from the user that is helpful for creating the topology description. However, the building system may provide just those options that the building system cannot determine without user input. In this manner, the user is relieved of tedious decision making. Further, the process of creating a topology description is streamlined, and the time for building such a topology description is reduced.

FIG. 4 is a diagram of an example of a method (400) for building a realized topology with a binding document according to the principles described herein. In this example, the method (400) includes generating (402) a binding document based on user input, assigning (404) values to the binding document, and building (406) a realized topology based on the binding document such that a user interface to the cloud is tied to the binding document and is independent of a cloud.

The binding document can define a relationship between the topology description objects and the cloud attributes. When the binding document is launched, the customer realized topology is realized (i.e. instantiated). In some examples, the method also includes changing the characteristics of the cloud without changing the user interface.

The user interface may display options in the binding document for changing the binding document that are compatible with the characteristics of the cloud. Those options that are not compatible with the cloud will not be given. Further, those attributes that are already assigned to existing objects are not displayed to the user because the attributes are already assigned.

For those values that are provided by the user, the building system may include a mechanism to validate these values to ensure that the user really does intend for those values to be associated with the topology description object.

The user may select an option to create a topology description object, select an existing object, remove a specified object, modify an existing object, execute another function, or combinations thereof. In response to the user selecting an option to create a topology description object, the building system may display a list of object attributes compatible with the cloud. In response to the user selecting an option to use an existing topology description object, the building system may hide the list of object attributes already specified for the existing realized topology object.

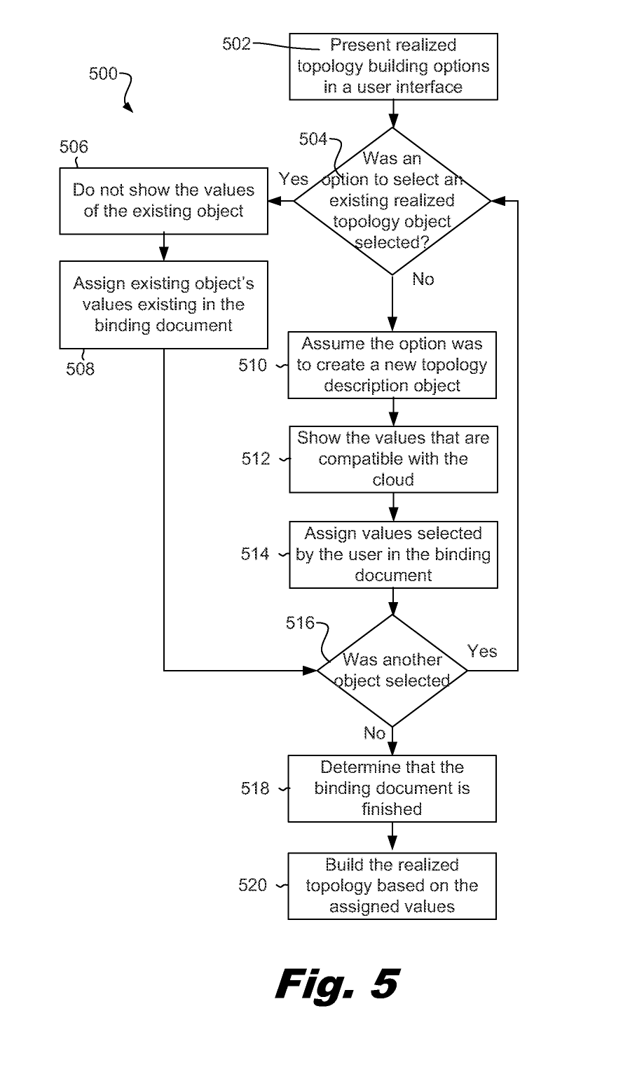

FIG. 5 is a diagram of an example of a method (500) for building a realized topology with a binding document according to the principles described herein. In this example, the method (500) includes presenting (502) realized topology building options in a user interface. The method (500) also includes determining (504) whether an option to select the existing realized topology object was selected. If so, the method (500) includes not showing (506) the values associated with the existing object, and assigning (508) the existing object's values in the binding document.

If selected option was not to select an existing object, the method continues by assuming (510) that the option was to create a new topology description object, showing (512) the values that are compatible with the cloud, and assigning (514) the values selected by the user in the binding document.

The method (500) continues by determining (516) whether another option was selected. If so, the method (500) continues by repeating the process of determining (504) which type of object was selected. If no other object was selected, the method (500) determines (518) that the binding document is finished, and builds (520) the realized topology based on the assigned values.

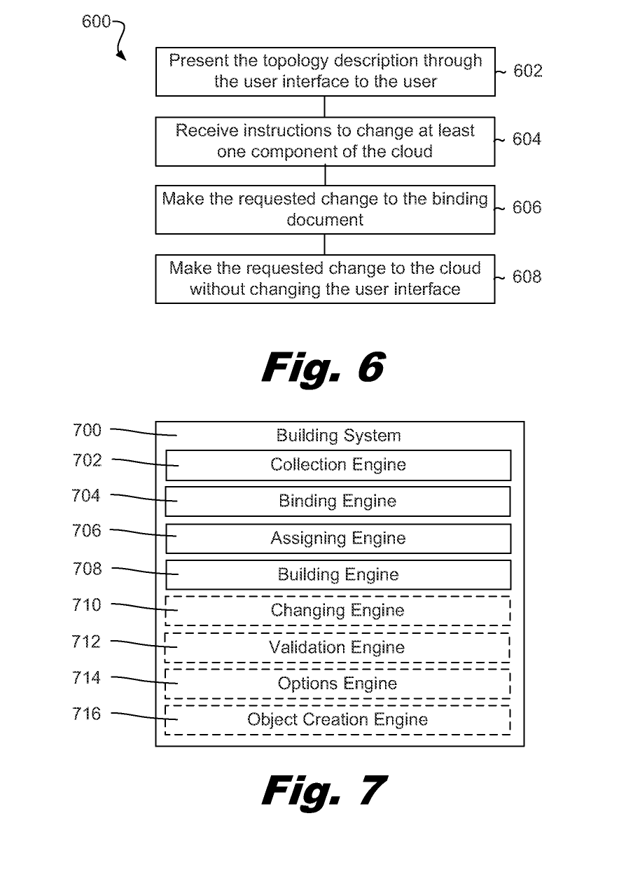

FIG. 6 is a diagram of an example of a method (600) for building a realized topology with a binding document according to the principles described herein. In this example, the method (600) includes presenting (602) the topology description through the user interface to the user, receiving (604) instructions to change at least one characteristic of the cloud, making (606) the requested change to the binding document, and making (608) the requested change to the cloud without changing the user interface. Such a method simplifies future proofing of the cloud and provides consistency for the user.

FIG. 7 is a diagram of an example of a building system (700) according to the principles described herein. The building system (700) includes a collection engine (702), a binding engine (704), an assigning engine (706), and a building engine (708). In this example, the building system (700) also includes a changing engine (710), a validation engine (712), an options engine (714), and an object creation engine (716). The engines (702, 704, 706, 708, 710, 712, 714, 716) refer to a combination of hardware and program instructions to perform a designated function. Each of the engines (702, 704, 706, 708, 710, 712, 714, 716) may include a processor and memory. The program instructions are stored in the memory and cause the processor to execute the designated function of the engine.

The collection engine (700) collects user input for what is desired to be in the customer realized topology. The options engine (714) can provide options to the user through the user interface to guide the user input. The object creating engine (716) creates an object in the binding document based on the user input. A validating engine (712) validates the values that are selected by the user to ensure that these values are the values that the user intends to use in the realized topology.

The binding engine (704) uses the input provided by the user to create the binding document. The assigning engine (706) assigns the appropriate values to the objects described in the binding document.

The building engine (708) builds a customer realized topology based on the binding document. The changing engine (710) changes the cloud based on changes to the binding document.

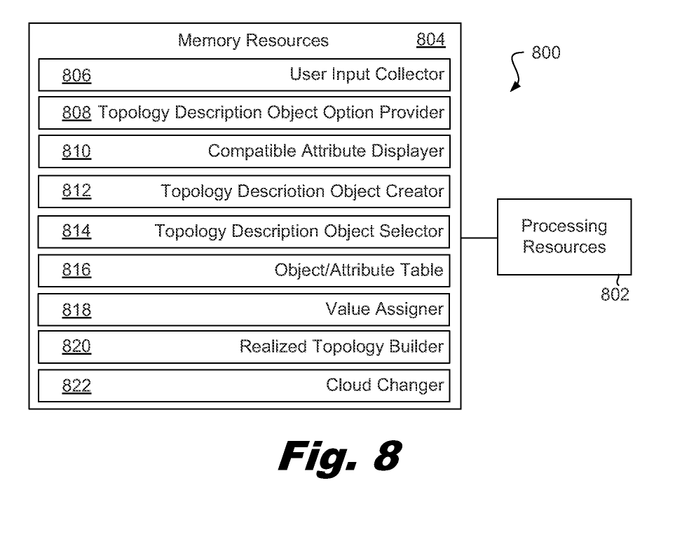

FIG. 8 is a diagram of an example of a building system (800) according to the principles described herein. In this example, the building system (800) includes processing resources (802) that are in communication with memory resources (804). Processing resources (802) include at least one processor and other resources used to process programmed instructions. The memory resources (804) represent generally any memory capable of storing data such as programmed instructions or data structures used by the building system (800). The programmed instructions shown stored in the memory resources (804) include a user input collector (806), a topology description object option provider (808), a compatible attribute displayer (810), a topology description object creator (812), a topology description object selector (814), a value assigner (818), a realized topology builder (820), and a cloud changer (822). The data structures shown stored in the memory resources (804) include an object/attribute table (816).

The memory resources (804) include a computer readable storage medium that contains computer readable program code to cause tasks to be executed by the processing resources (802). The computer readable storage medium may be tangible and/or non-transitory storage medium. The computer readable storage medium may be any appropriate storage medium that is not a transmission storage medium. A non-exhaustive list of computer readable storage medium types includes non-volatile memory, volatile memory, random access memory, memristor based memory, write only memory, flash memory, electrically erasable program read only memory, magnetic storage media, other types of memory, or combinations thereof.

The user input collector (806) represents programmed instructions that, when executed, cause the processing resources (802) to collect user input for what is desired in the customer topology description. The topology description object option provider (808) represents programmed instructions that, when executed, cause the processing resources (802) to provide to the user through the user interface options to create a topology description object. The compatible attribute displayer (810) represents programmed instructions that, when executed, cause the processing resources (802) to display attributes that are compatible with the cloud in response to a user selecting an option to create a topology description object. The topology description object creator (812) represents programmed instructions that, when executed, cause the processing resources (802) to create the topology description object based on the user's input.

The topology description object selector (814) represents programmed instructions that, when executed, cause the processing resources (802) to select an existing topology description object for use in the customer topology description. In an example where the user selects an already existing realized topology object for use in the customer topology description, the existing realized topology object already has attributes associated with it. As a consequence, options are not provided to the user for selecting the attributes. In some examples, the attributes of the existing realized topology object may be hidden from the user. In such an example, the user may request to see the hidden attributes for his reference or to make a change. However, under such a circumstance, the building system (800) keeps these attributes hidden as a default.

The object/attribute table (816) may be the data structure that tracks the relationships between the topology description objects and the cloud attributes. The value assigner (818) represents programmed instructions that, when executed, cause the processing resources (802) to assign values to the topology description objects in the binding document. If the user created a topology description object in the binding document, the value assigner (818) may assign the values that were selected by the user. If the user selected to use an existing realized topology object, the values already associated with that object will be assigned to the topology description object in the binding document unless otherwise instructed by the user.

The realized topology builder (820) represents programmed instructions that, when executed, cause the processing resources (802) to build the realized topology on the cloud based on the binding document. The cloud changer (822) represents programmed instructions that, when executed, cause the processing resources (802) to change the cloud based on changes to the binding document without changing the user interface.

Further, the memory resources (804) may be part of an installation package. In response to installing the installation package, the programmed instructions of the memory resources (804) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (802) and the memory resources (804) are located within the same physical component, such as a server, or a network component. The memory resources (804) may be part of the physical component's main memory, caches, registers, non-volatile memory, or elsewhere in the physical component's memory hierarchy. Alternatively, the memory resources (804) may be in communication with the processing resources (802) over a network. Further, the data structures, such as the libraries, may be accessed from a remote location over a network connection while the programmed instructions are located locally. Thus, the building system (800) may be implemented on a user device, on a server, on a collection of servers, or combinations thereof.

The building system (800) of FIG. 8 may be part of a general purpose computer. However, in alternative examples, the building system (800) is part of an application specific integrated circuit.

While the examples above have been described with reference to specific binding document formats, any appropriate format for the binding document may be used. For example, the binding document may include tables, free text fields, other formats, or combinations thereof. Further, while the examples above have been described with reference to specific mechanism for collecting user input about the customer realized topology desired characteristics, any appropriate mechanism to collect user input may be used.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A computer program product for building a realized topology with a binding document, comprising:
a non-transitory computer readable storage medium that comprises program instructions that, when executed, causes a processor to:
generate a binding document based on user input;
assign values to said binding document; and
build a realized topology based on said binding document such that a user interface to said topology description is tied to said binding document and is independent of said cloud.

2. The computer program product of claim 1, further comprising program instructions that, when executed, cause said processor to change said cloud without changing said user interface.

3. The computer program product of claim 1, wherein said binding document defines a relationship between topology description objects and cloud attributes.

4. The computer program product of claim 1, further comprising program instructions that, when executed, cause said processor to display in said binding document options for changing said binding document that are compatible with said cloud.

5. The computer program product of claim 1, further comprising program instructions that, when executed, cause said processor to validate said assigned values that are based on user input.

6. The computer program product of claim 1, further comprising program instructions that, when executed, cause said processor to create said binding document based on said user input selecting an option to create a topology description object.

7. The computer program product of claim 1, further comprising program instructions that, when executed, cause said processor to display a list of compatible object attributes in response to said user input to create said topology description object.

8. The computer program product of claim 1, further comprising program instructions that, when executed, cause said processor to create said binding document based on said user input selecting an option to use an existing realized topology object.

9. The computer program product of claim 1, further comprising program instructions that, when executed, cause said processor to hide a list of object attributes in response to said user input to select an existing realized topology object.

10. A system for building a realized topology with a binding document, comprising:
a collection engine to collect user input about desired topology description parameters;
a binding engine to generate a binding document based on user input;
an assigning engine to assign values to said binding document; and
a building engine to build a realized topology based on said binding document such that a user interface to said cloud is tied to said binding document and is independent of said cloud.

11. The system of claim 10, further comprising a changing engine to change said cloud without changing said user interface.

12. The system of claim 10, further comprising a validating engine to validate said assigned values that are based on user input.

13. The system of claim 10, further comprising an option engine to display in said binding document options for changing said binding document that are compatible with said cloud.

14. The system of claim 10, further comprising an object creating engine to create a topology description object based on said user input.

15. A system for building a realized topology with a binding document, comprising:
collecting user input about desired cloud parameters;
generating a binding document based on user input;
assigning values to said binding document;
building a realized topology based on said binding document such that a user interface to said cloud is tied to said binding document and is independent of said cloud; and
changing said cloud without changing said user interface.
